(19) United States
(12) Patent Application Publication
(10) Pub. No.: US 2011/0024707 A1
(43) Pub. Date: Feb. 3, 2011

(54) Bumper Rail System Shock Absorber

(76) Inventors: Johnie E. Williams, Fayetteville, GA (US); John R. Williams, Fayetteville, GA (US)

Correspondence Address: ERIC W. CERNYAR, P.C., 1122 GOLDEN CYCLE CIRCLE, CRIPPLE CREEK, CO, 80813, US

(21) Appl. No.: 12/511,802

(22) Filed: Jul. 29, 2009

(51) Int. Cl. E01F 15/00; B23P 17/00; B23P 6/00

(52) U.S. Cl. 256/13.1; 29/592; 29/401.1

(57) ABSTRACT

A bumper rail assembly is provided that uses bars of arch-shaped spring steel, mounted in a standing-arch configuration, as shock absorbers for the bumper rails. An end portion of the spring steel bar is shaped into a saddle so that the spring steel bar can be secured indirectly, by means of a metal plate or bracket, to the concrete base. The assembly minimizes shear forces on the anchor bolts, offers performance advantages over conventional shock absorbers such as used tires, and is economically competitive with conventional shock absorbers.

### FIELD OF THE INVENTION

This invention relates generally to bumper rails, and more particularly to shock absorbers for bumper rails.

### BACKGROUND OF THE INVENTION

FIG. 1 illustrates a go cart track 5 with two bumper rails 6 extending around both sides of the full length of the track 5. A common bumper rail 6 is configured to deflect when impacted by a cart and comprises a steel band, or suitable material, with an approximate 5-inch by 0.625-inch cross section. The bumper rails 6 are commonly backed by used automobile tires 3 or other rubber devices that serve as shock absorbers for the rails 6.

Tires perform their function reasonably well, as long as the impact load on the rail system is low or moderate. But in areas of the track that receive frequent high-load impacts, the tires often become permanently deformed, particularly when the impact loads exceed the elastic limit of the tires. Eventually, the elasticity of many tires decay so much that the tires are rendered crumpled and useless. FIG. 2 illustrates some tires in the early stages of this deformation process.

After a tire is spent, it is common to remove the tire, re-straighten the bumper rail, and install a new tire. This type of maintenance may have to be performed many times depending on the track design and usage.

Despite these inconveniences, used tires are relatively cheap and easy to obtain and relatively easy to install. These and other factors have served to suppress prior art motivation to replace the tires with a different shock absorbing system.

One of the Applicants owns a small amusement park that includes a go cart track. Applicants, moreover, enjoy making innovations even in areas where a person of ordinary skill, content with conventional techniques, might lack any motivation to innovate. This drive led Applicants to explore replacing tires with leaf springs similar to auto leaf springs.

Applicants' investigations made them aware of one prior art leaf-spring-based shock absorbing system installed at a track in Florida. The system, which is herein referred to as the “Shaller design,” is illustrated in FIG. 3. The Shaller design replaces each tire 3 with an arch-shaped leaf spring 90 installed lying on its side—that is, with its radial cross-section in a horizontal (non-upright) position. One end of the arch-shaped leaf spring 90 is welded to a sleeve 99 which is secured to the concrete base 2 by an anchor bolt 91.

Although Applicants were informed that the Shaller design performed well, Applicants also realized that it was relatively expensive to fabricate. So Applicants conceived, tested, and refined alternative systems. Applicants tried different leaf spring sizes, configurations (including a “V” shaped design), and fastening alternatives. Many of Applicants' experimental designs resulted in failures where the spring was anchored to the concrete base, due to the intense side bending loads imposed on the concrete anchor. After repeated refinements, Applicants developed a design that is both economical and robust.

### SUMMARY OF THE INVENTION

A spring is provided as a shock absorber for a bumper rail system. The spring—preferably but not necessarily taking the form of a four-inch by one-quarter-inch bar of 5160 spring steel—is shaped into an arch configuration and mounted in a standing arch configuration. An end portion of the spring bar is shaped into a saddle so that the spring bar can be secured indirectly, by means of a metal plate or bracket, to the concrete base.

The current invention has proven not only to be more effective and robust than used tires, but also competitive in price. The invention is easy to fabricate and easy to install.

Additional advantages of the present invention—which were not apparent when conceptualizing the design but which became apparent after testing of the invention—included (1) the ability to add more springs between existing ones in high impact areas and (2) the practicality of re-straightening the springs when they become over-stressed. Other environmental, maintenance, and financial benefits include (3) potential savings on new track installations, (4) the ability to retrofit existing tracks while using the same bolt that was used to secure the tire to the rail to secure the spring to the rail; (5) the avoidance of having rainwater and debris collect inside the tires, (6) the fact that it is more feasible to recycle spent steel than spent tires, and (7) the fact that spent steel can be sold at a small profit for scrap, whereas spent tires require a disposal fee.

Part of what makes the present invention so innovative and remarkable is its simplicity and economy. It comprises only a few different parts and is easy to use. But despite its simplicity, the present invention provides numerous advantages over conventional approaches. Those of ordinary skill in the art will appreciate these and other improvements described further below in the detailed description and the accompanying drawings.

### BRIEF DESCRIPTION OF THE DRAWINGS

FIG. 1 illustrates a go-cart track with used tires employed as shock absorbers for the rails.

FIG. 2 illustrates a portion of a go-cart track with used tires employed as shock absorbers for the rails.

FIG. 3 illustrates a portion of a go-cart track with shock-absorbing leaf springs lying on their sides and secured to the concrete base of the track by an anchor-bolt sleeve welded to the spring.

FIGS. 4-6 illustrate a portion of a go-cart track with one embodiment of a bumper rail assembly according to the present invention, including shock-absorbing springs mounted in a standing arch configuration and a saddle for anchoring the springs to the concrete base.

FIG. 7 is a side view of one embodiment of an arch-shaped spring configured in accordance with the present invention.

FIG. 8 is a perspective view of one embodiment of an arch-shaped spring configured in accordance with the present invention.

FIG. 9 is a top view of a bar of spring steel before it is formed into the arch-shaped spring of FIG. 8.

FIG. 10 is a top view of the bar of FIG. 10, showing a drilled hole location and lines along which the bar is bent to form the saddle portion and the opposite end portion.

FIG. 11 is a side view of the bar of FIG. 9.

FIG. 12 is a side view of the bar of FIG. 10, after the saddle and opposite end portions have been bent.

FIG. 13 is a perspective view of one embodiment of an anchor bracket.

FIG. 14 is a perspective view of one embodiment of the arch-shaped spring and bracket assembly.

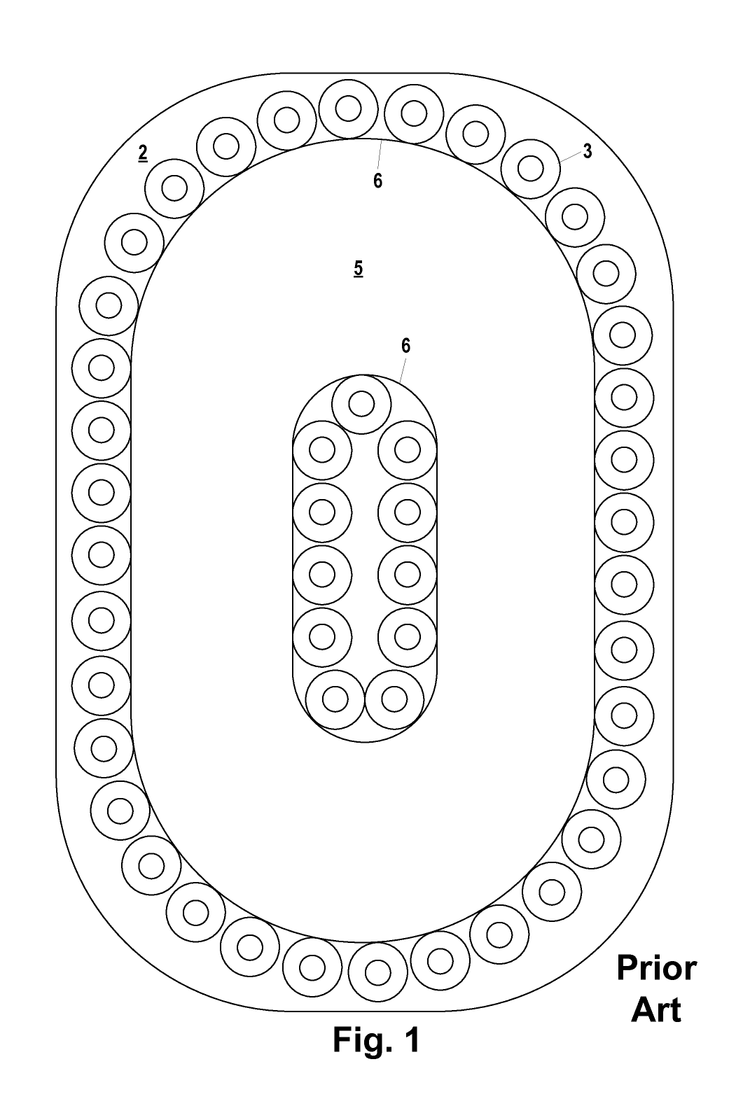

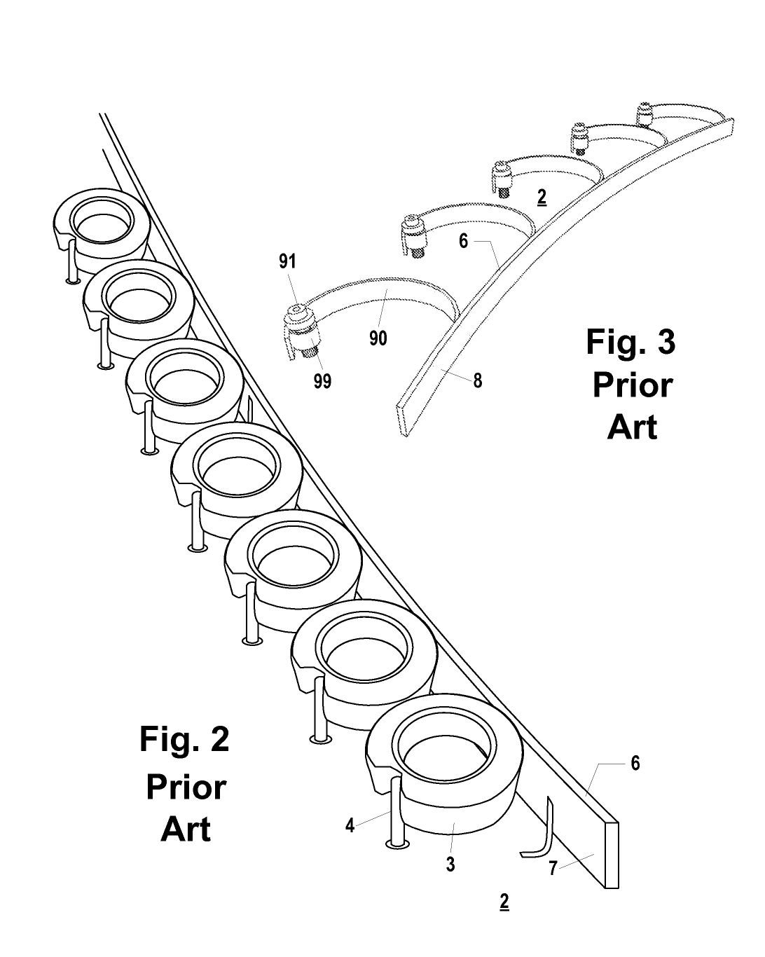

### DETAILED DESCRIPTION

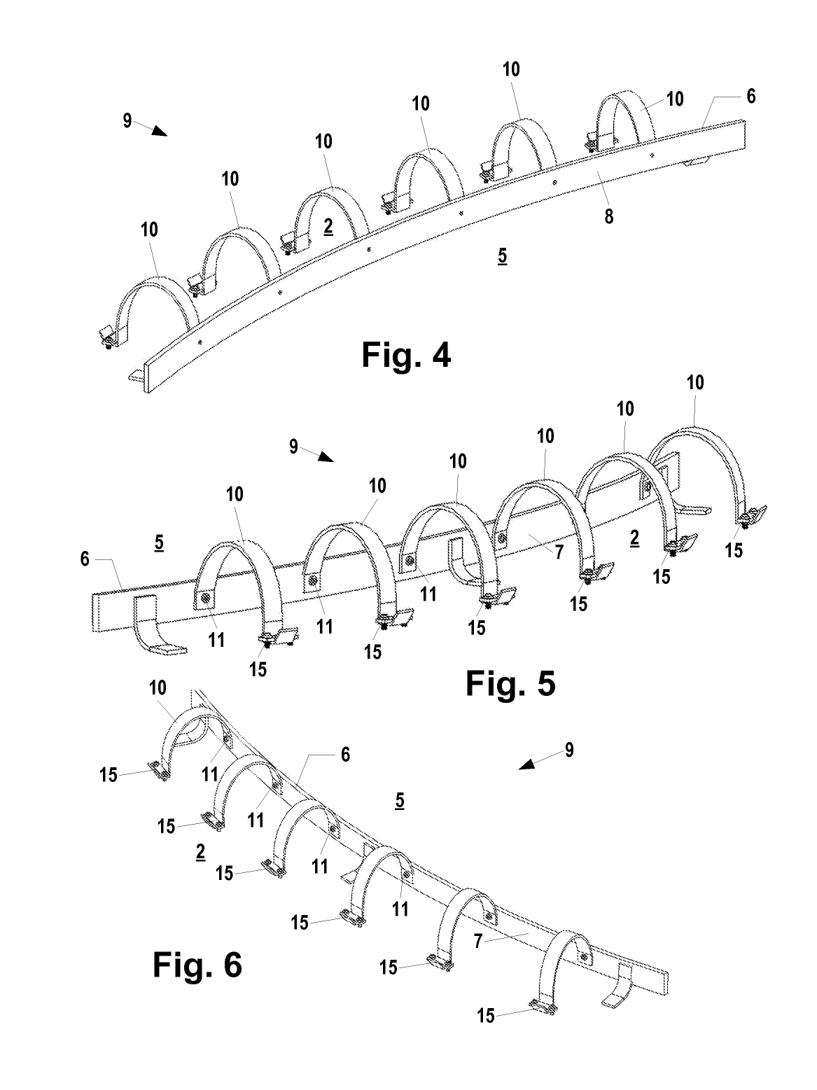

FIGS. 4-6 illustrate one embodiment of a bumper rail assembly 9 for a go cart track 5. The bumper rail assembly 9 comprises a track rail 6 in the form of a metal band extending along and near an edge of the track 5. The track rail 6 has an outer side 7 facing away from the track 5 and an inner side 8 facing the track 5. The bumper rail assembly 9 is configured to resiliently deflect impacts from go carts. A plurality of bumper rail springs 10, each taking the form of an arch- or arcuate-shaped leaf spring, back up the track rail 6. Each bumper rail spring 10 is coupled to and positioned in a standing arch configuration on the outside 7 of the track rail 6.

Each arch-shaped spring 10 is fastened to the track rail 6 by means of a fastener 11 that secures a first end of the spring 10 to the track rail 6. The fastener 11 will often be a bolt 12 (FIG. 14) that is welded to the track rail 6, which penetrates a hole 55 (FIG. 10) in the first end of the spring 10. The bolt 12 is secured to the spring 10 by a nut 13 (FIG. 14). In retrofitting situations, the fastener 11 is preferably the same bolt 12 that had been used to secure a tire 3 or other shock absorber.

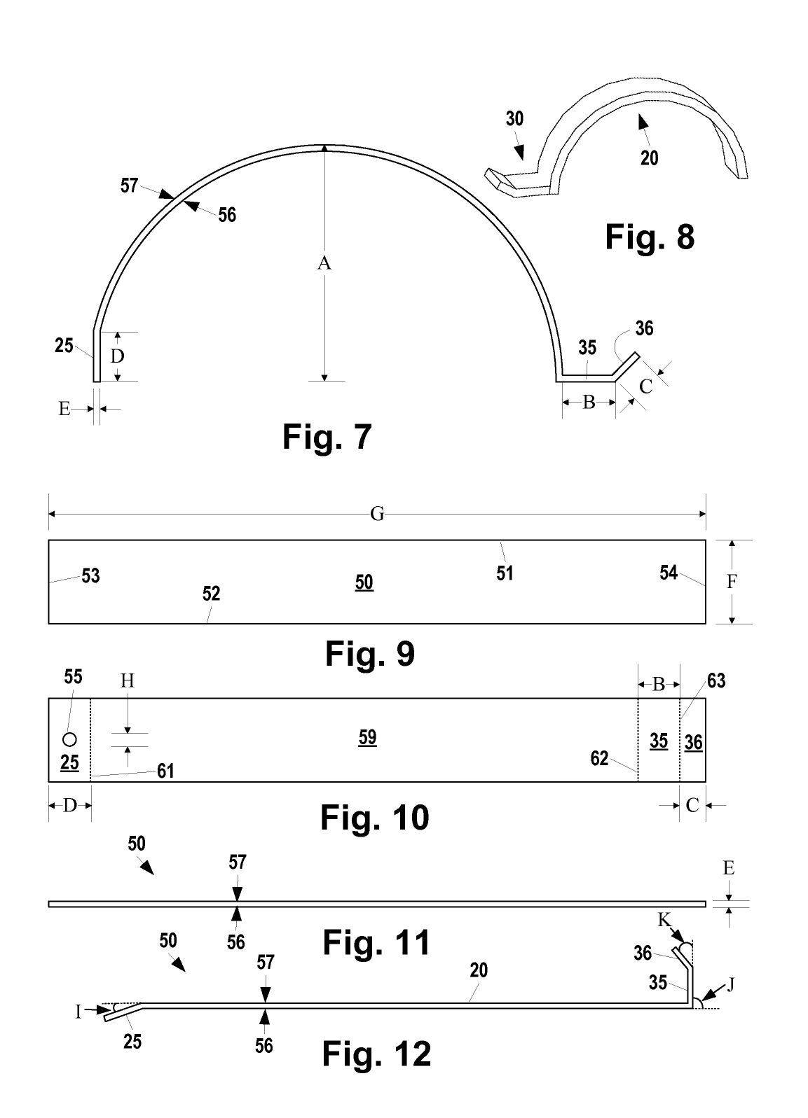

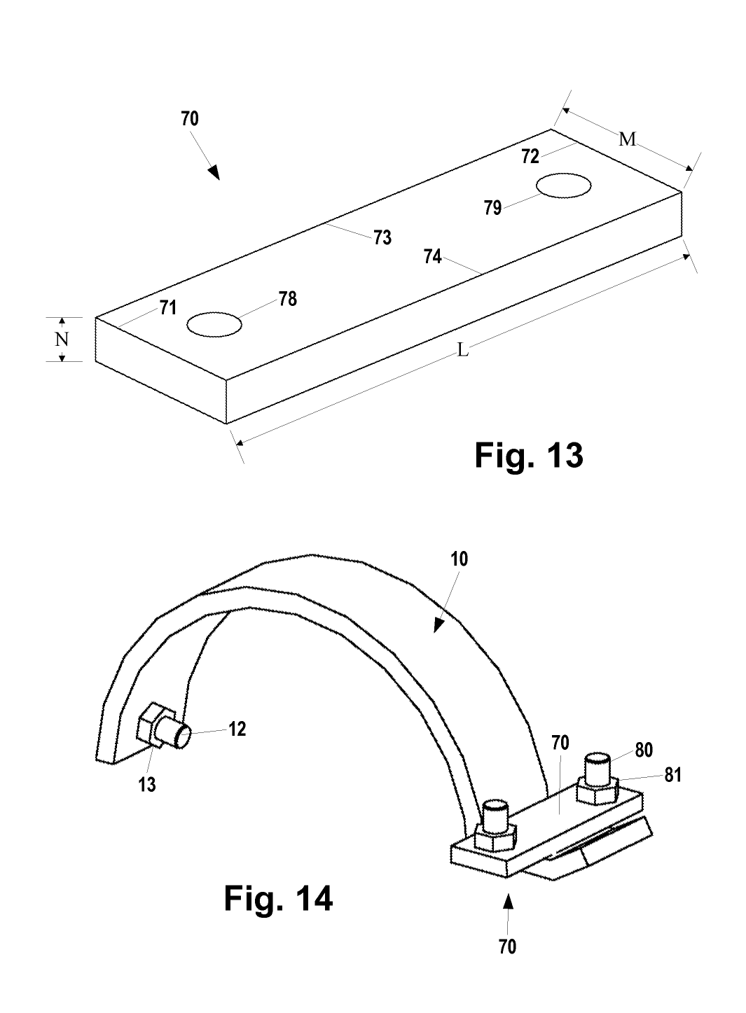

An anchor 15 indirectly secures the second end, opposite the first end, of the spring 10 to a concrete base 2 that extends alongside the perimeter of the track 5. In preferred embodiments, the second end of each arch-shaped spring 10 is formed in the shape of a saddle 30 (FIG. 8), including a bracket or saddle seat 35 and an upturned section 36 (FIG. 7). An anchor bracket 70 (FIGS. 13-14) straddles the saddle 30 to secure the spring 10 to the concrete base 2. In its simplest form, the anchor bracket 70 comprises a rectangular, planar metal plate (FIG. 13) with a thickness N of about one-half an inch, sides 73 and 74 each having a length L of about six and three-eighths inches, and sides 71 and 72 each having a width M of about two inches. The anchor bracket 70 also includes two nine-sixteenth-of-an-inch-diameter holes 78 and 79 spaced about 4.25 inches apart and otherwise centered in the bracket 70. The anchor bracket 70 is secured to the concrete base 2 by two concrete anchor bolts 80 and nuts 81.

In stating that the anchor 15 indirectly secures the spring 10 to the concrete base 2, Applicants mean to contrast the anchor 15 from systems that would incorporate a bolt that is inserted through a hole in the spring 10 or through a sleeve or other device welded to the spring 10.

The saddle 30 and bracket 70 configuration gives the second end of the spring 10 some play to move laterally with respect to bracket 70 as the spring 10 receives strong compressive forces. The upturned section 36 also accommodates upward deflection of the first end of the spring 10.

The saddle 30 and bracket 70 configuration also converts some of the spring compressive force that would otherwise tend to shear the bolts 80 into a tensile force against the bolts 80. Applicants' experimentation has shown this configuration, on the whole, significantly reduces the problem of anchor bolts 80 being sheared.

FIGS. 7-12 illustrate the dimensions and formation process of one preferred embodiment of the bumper rail spring 10.

To form the bumper rail spring 10, an elongate flat rectangular bar 50 (FIGS. 9, 11) of steel is obtained. In a preferred embodiment, the bar 50 is made of spring steel, and more particularly, 5160 carbon-chromium spring steel. Spring steel is a low alloy, medium carbon steel with a very high yield strength. Objects made of spring steel can return to their original shape despite significant bending and twisting. The bar 50 has a top face 57, a bottom face 56, a rail-proximate end 53, a rail-distal end 54, and opposing sides 51 and 52. The bar 50 has a length G of between 2 and 4 feet—in one embodiment approximately 33.5 inches—a width F of approximately four inches, and a thickness E of approximately one-quarter of an inch. The dimensions may be varied somewhat, but Applicants have found through experimentation that the bar 50 should have a cross-sectional surface area substantially greater than 0.5 square inches. As shown in FIG. 10, a single hole 55 having a diameter H of about five-eighths of an inch is drilled about one inch from the rail-proximate end 53, centered between sides 51 and 52. The hole 55 is meant to accommodate a pre-existing anchor bolt 12 (FIG. 14) welded onto the steel band of a go-cart track.

As illustrated in FIG. 12, a rail-proximate end portion 25 of the bar 50, having a length D of about 2 inches, is bent along line 61 downward at an angle I of between about 3 and 10 degrees. A short section of the opposite end of the bar 50, having a length C of about 1.25 inches, is bent upward along line 63 at an angle K of about 20-45 degrees to form the upturned section 36. An adjoining section, having a length B of about 2 inches, is bent upward along line 62 at an angle J of about 75 to 90 degrees, to form the saddle seat section 35.

Finally, a long intermediate section 59 spanning about 28 inches between lines 61 and 62 is bent convexly—from the perspective facing the front face 57—into an arch 20 having a radius A of approximately 9 inches. The arch does not have to be entirely circular or elliptical. Indeed, it may be skewed so that the portion of the arch 20 closest to the saddle 30 has a flatter curve.

The present invention also contemplates the following method of improving a go-cart track 5 having a track rail 6 braced with tires 3 or other shock absorber to absorb shock. The method comprises the steps of removing one of the tires 3 or other shock absorbers and replacing it with an arch-shaped spring 10. The arch-shaped spring 10 is formed from a bar 50 of spring steel, a section of which has been shaped into an arch 20, and another section of which has been shaped into a saddle 30. The spring 10 is mounted in a standing arch configuration to the bumper rail 6 and a concrete base 2. The bar 50 is indirectly anchored to the concrete base 2 by an anchor bracket 70 that straddles the saddle 50 and which is secured to the concrete base 2 by bolts 80.

Although the foregoing specific details describe various embodiments of the invention, persons reasonably skilled in the art will recognize that various changes may be made in the details of the apparatus or method of this invention without departing from the spirit and scope of the invention as defined in the appended claims.

The present invention includes several independently meritorious inventive aspects and advantages. Unless compelled by the claim language itself, the claims should not be construed to be limited to structures that incorporate all of the inventive aspects, or enjoy all of the advantages, disclosed herein.

We claim:

1. A bumper rail assembly for a go cart track comprising:
a metal band extending along and near an edge of the track, the metal band having an outer side facing away from the track;
an arch-shaped spring coupled to and positioned in a standing arch configuration on the outside of the metal band;
a fastener that secures a first end of the spring to the metal band; and
an anchor that secures a second end, opposite the first end, of the spring to a base.

2. The bumper rail assembly of claim 1, wherein the spring is anchored indirectly to the base.

3. The bumper rail assembly of claim 1, wherein the anchor comprises an anchor bracket secured to the base.

4. The bumper rail assembly of claim 3, wherein the anchor bracket comprises a metal plate secured to the base by at least two anchor bolts.

5. The bumper rail assembly of claim 1, wherein the second end of the spring comprises a saddle and wherein the anchor straddles the saddle to secure the spring.

6. The bumper rail assembly of claim 5, wherein the anchor comprises an anchor bracket secured to the base by at least two anchor bolts.

7. The bumper rail assembly of claim 1, wherein the second end of the spring comprises an upturned section, the upturned section accommodating upward deflection of the first end of the spring.

8. The bumper rail assembly of claim 1, wherein the fastener comprises a bolt welded to the metal band, the bolt penetrating a hole in the first end of the spring, and the bolt being secured to the spring by a nut.

9. The bumper rail assembly of claim 1, wherein the spring comprises an arcuate leaf spring.

10. The bumper rail assembly of claim 1, wherein the spring is formed from a bar of spring steel.

11. The bumper rail assembly of claim 10, wherein the bar has a cross-section of about four inches by one-quarter of an inch.

12. A bumper rail spring formed by a process comprising the steps of:
obtaining an elongate bar of spring steel;
bending a long section, intermediate two relatively shorter end sections, of the bar into an arch; and
bending one of the end sections of the bar into a saddle configured to receive an anchor bracket.

13. The bumper rail spring of claim 12, wherein the elongate bar is between 2 and 4 feet in length.

14. The bumper rail spring of claim 12, wherein the elongate bar has a cross-sectional surface area substantially greater than 0.5 square inches.

15. The bumper rail spring of claim 12, wherein the process further comprises the step of drilling a hole in an end of the elongate bar to accommodate an anchor bolt of a steel band of a go-cart track.

16. A method of improving a go-cart track having a bumper rail braced with pre-existing shock absorbers to absorb shock, the method comprising:
removing at least one of the pre-existing shock absorbers;
replacing at least one of the removed pre-existing shock absorbers with a bar of spring steel, a section of which bar has been shaped into an arch;
mounting the bar of spring steel, in a standing arch configuration, to the bumper rail and a base.

17. The method of claim 16, further comprising indirectly anchoring the bar of spring steel to the base.

18. The method of claim 17, wherein an end section of the bar has been shaped into a saddle, the method further comprising straddling the saddle with an anchor bracket and securing the bracket to the base with bolts.

19. The method of claim 16, wherein at least one of the removed pre-existing shock absorbers is a tire.

20. The method of claim 19, wherein the tire had been secured to the rail with a pre-existing welded bolt, the method further comprising the step of securing the bar of spring steel to the bumper rail via the pre-existing welded bolt.
